(19) United States
(12) Patent Application Publication
(10) Pub. No.: US 2013/0244471 A1
(43) Pub. Date: Sep. 19, 2013

(54) COUPLING APPARATUS FOR HIGH POWER ELECTRICAL CONNECTORS

(71) Applicants: Stephen Seymour James Andrew, McKay (AU); John Piccolo, Trinity Beach (AU)

(72) Inventors: Stephen Seymour James Andrew, McKay (AU); John Piccolo, Trinity Beach (AU)

(73) Assignee: Anolo Holdings Pty Ltd, McKay (AU)

(21) Appl. No.: 13/884,312

(22) PCT Filed: Nov. 9, 2011
(86) PCT No.: PCT/AU2011/001443

§ 371 Date: May 29, 2013

(30) Foreign Application Priority Data
Nov. 9, 2010 (AU) 2010904951

(51) Int. Cl. H01R 13/629

(52) U.S. Cl. CPC H01R 13/629
USPC 439/369

(57) ABSTRACT

A coupler for mating high power electrical connectors as may be used in mining environments includes a frame 39 upon which are mounted a first retaining assembly 11 and a second retaining assembly 12 for retaining respective electrical connector assemblies. The retaining assemblies may be brought relatively toward and away from each other by a translation assembly which comprises a rack 6 mounted to the frame and which meshes with a pinion 7. The pinion 7 is coupled to a drive train of the second retaining assembly which is driven by an axle 16, to one end of which there is mounted a wheel 4. Accordingly, upon a worker rotating wheel 4 the second retaining assembly 12 may be brought toward and away from the first retaining assembly 11. A rotation assembly is incorporated into one of the retaining assemblies for rotationally aligning the connector assemblies.

### TECHNICAL FIELD

The present invention relates to an apparatus for assisting in the connecting together of electrical connectors for very heavy duty cables.

### BACKGROUND

The discussion of any prior art documents, techniques, methods or apparatus is not to be taken to constitute any admission or evidence that such prior art forms, or ever formed, part of the common general knowledge.

Very heavy duty electrical cables are found in a number of contexts including mining. These cables are capable of meeting the very high power requirements of large electrical machines. For example, cables capable of carrying 800 Amp currents at 22,000V may be used in such environments.

The cables are typically terminated with specially made electrical connectors. In order to join one length of cable to another the corresponding end connectors must be appropriately manipulated so that they can be interconnected.

However, cables of this type are very heavy and have little flexibility. For example, heavy duty power cables used in underground or open cut mines are frequently made with lead insulation and steel wire armor over copper conductors. In order to manipulate the cables so that they can be interconnected a number of workers are typically required to lift and align the cables and connectors.

It will be realized that this presents a laborious and time intensive job which has the potential to injure to workers.

Furthermore, the workers have been known to inadvertently rupture the electrical connection inside a connector so that once the connectors are interconnected, correct functionality of the joined cables is lost.

It is an object of the present invention to provide an apparatus that addresses one or more of the above-described problems.

### SUMMARY OF THE INVENTION

According to a first aspect of the present invention there is provided a coupler to interconnect first and second connector assemblies of respective first and second electrical cables and able to be released from the cables after interconnection, the coupler including:

a first retaining assembly to retain the first connector;

a second retaining assembly to retain the second connector with the first connector;

a translation assembly for relative motion of said first assembly and said second assembly toward each other to thereby mate the first connector with the second connector.

Preferably at least one of the first and second retaining assemblies includes an arrangement for rotation of at least one of the first or second connector.

Preferably the translation assembly is arranged to move at least one, or both, of the first and second retaining assemblies toward each other.

In the preferred embodiment the first retaining assembly includes the arrangement for rotation of the first connector.

In a further embodiment of the invention the second retaining assembly is also arranged to rotate the second connector assembly.

In the first embodiment the translation assembly is arranged to move the second retaining assembly toward the first retaining assembly.

Preferably the first retaining assembly comprises a first yoke for retaining the first retaining assembly. The first yoke may be formed in opposing parts which can be opened to receive the first connector assembly. In a preferred embodiment the opposing parts define a receptacle for a sleeve, or as it may be called an “adaptor”, which holds the first connector in use.

A power actuator is preferably provided to open and close the first yoke.

Preferably a drive train is provided for rotating the sleeve within the yoke.

The drive drain may include a drive pinion arranged to mesh with teeth formed about the sleeve.

Preferably the sleeve is formed of a resilient material such as polypropylene or polyurethane or nylon to thereby cushion the connector.

In a first embodiment the drive chain is driven by a wheel for rotation by an operator. Alternatively, the drive chain may be driven by a motor.

Preferably the second retaining assembly comprises a second yoke for retaining the second connector assembly. The second yoke may be formed in opposing parts which can be opened to receive the first connector. In a preferred embodiment the opposing parts define a receptacle for a sleeve or “adaptor” which holds the second connector in use.

In the preferred embodiment the opposing parts of the second yoke are hingedly connected by a pivot pin so that a first part of the first yoke may be pivoted away from a second part of the second yoke.

A power actuator is preferably provided to open and close the second yoke.

The translation assembly may comprise a rack and pinion arrangement associated with the second retaining assembly. Preferably the first retaining assembly and the second retaining assembly are mounted upon a common frame.

In a first embodiment the rack is fast with the frame and the pinion is fast with the second retaining assembly. In the first embodiment the pinion is coupled to a drive wheel for rotation by an operator.

In a second embodiment the first retaining assembly and the second retaining assembly are brought towards each other by means of powered actuators. For example, the powered actuators may comprise hydraulic rams arranged to slide the first retaining assembly and the second retaining assembly along members of the frame.

Preferably cable supports are mounted adjacent the first retaining assembly and the second retaining assembly for supporting respective cables of the first connector and the second connector.

The cable supports may comprise rotatable sheaves.

Preferably cable guides are provided for assisting in directing cables of the connector assemblies to respective cable supports during use.

Preferably respective powered risers are provided at opposite sides of the apparatus for lifting of the first cable and the second cable to assist in installing and removing the connector assemblies to and from the retaining assemblies. The powered risers preferably include telescopic arms coupled to power actuators.

Preferably the telescopic arms include pulleys through which lines run for attachment to the connector assemblies for lifting thereof.

In a preferred embodiment the frame is coupled to the stand via a linkage including a pivot for tilting the frame relative to the stand so that the first and second retaining assemblies may be tilted down to reduce the height through which connectors must be lifted for installation in the first and second retaining assemblies.

In an embodiment of the invention designed for use on sloping ground, as may be found in underground mines for example, the frame is pivotally mounted to a stand so that the frame may be rolled through a first angle relative to the stand. The stand may comprise a platform or a “basket” for an operator to stand in while using the coupling apparatus.

Preferably a motor is provided to adjust a pivot angle between the frame and the stand so that the frame may be kept at a desired angle, for example horizontal, irrespective of the slope of the surface supporting the stand.

According to a further aspect of the present invention there is provided an adaptor for an electrical connector comprising:

at least first and second parts defining a space for snugly receiving an electrical connector therein; and

an external surface for forcing by a rotation member.

In a first embodiment the at least first and second parts comprise two portions that are detachably interlocked.

Preferably the external surface is formed for meshing with gears of a pinion to thereby impart rotation.

### BRIEF DESCRIPTION OF THE DRAWINGS

The Detailed Description is not to be regarded as limiting the scope of the preceding Summary of the Invention in any way. The Detailed Description will make reference to a number of drawings as follows:

FIG. 1 is a side view of a coupling apparatus according to a first embodiment of the present invention.

FIG. 2 is an end view of the coupling apparatus of FIG. 1.

FIG. 3 is a top plan view of the coupling apparatus of FIG. 1.

FIG. 4 is a perspective view of a sleeve or adaptor according to a first embodiment of an aspect of the present invention.

FIG. 5A is a side view of the adaptor of FIG. 4.

FIG. 5B is a front plan view of the adaptor of FIG. 4.

FIG. 5C is a cross-section through the adaptor of FIG. 4.

FIG. 6 is a perspective view of a cradle according to an embodiment of an aspect of the present invention in use.

FIG. 7 is an isometric view of a coupling apparatus according to a further embodiment of the present invention.

FIG. 8 is a side plan view of the coupling apparatus of FIG. 7.

FIG. 9 is a top plan view of the coupling apparatus of FIG. 7.

FIG. 10 is an end view of the coupling apparatus of FIG. 7.

FIG. 11 is an end view of the coupling apparatus of FIG. 7 in a tilted configuration with retracted arms.

FIG. 12 is an end view of the coupling apparatus of FIG. 7 in a tilted configuration with extended arms.

FIG. 13 is a non-planar view of the coupling apparatus of FIG. 7 in use during the raising of a connector assembly.

FIG. 14 is an end view of the coupling apparatus of FIG. 7 in a non-tilted configuration with open yokes.

FIG. 15 is an isometric view of a coupling apparatus according to a further embodiment of the invention intended primarily for use in underground mines.

FIG. 16 is a top plan view of a slight variation of the coupling apparatus of FIG. 15 wherein a gate has been replaced with a vehicle mounting bracket.

FIG. 17 is a side view of the coupling apparatus of FIG. 16.

FIG. 18 is a view of the coupling apparatus of FIG. 16 wherein the coupling assembly has been rolled anti-clockwise relative to resting position.

FIG. 19 is a view of the coupling apparatus of FIG. 16 wherein the coupling assembly has been rolled clockwise relative to resting position.

FIG. 20 is a top planar view of a coupling apparatus according to an embodiment of the invention including two rotation assemblies for rotating yokes of the apparatus.

FIG. 2 comprises various views of a second embodiment of a coupler according to the present invention.

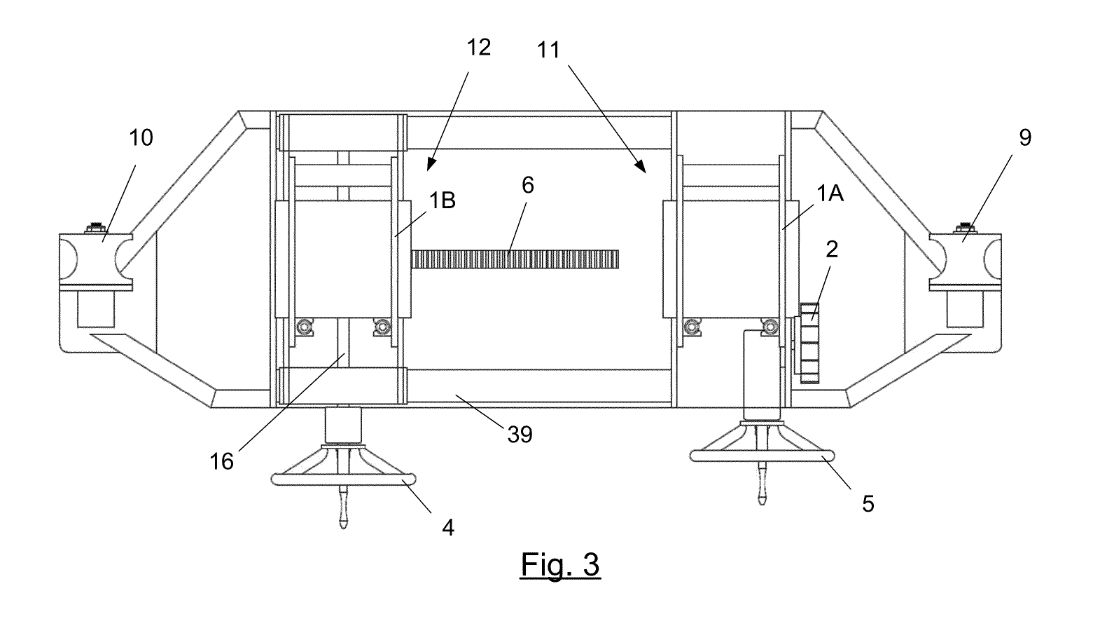

FIG. 3 illustrates a connector sleeve and drive sprocket used in the various embodiments of the invention.

Preferred features, embodiments and variations of the invention may be discerned from the following Detailed Description which provides sufficient information for those skilled in the art to perform the invention.

### DETAILED DESCRIPTION OF PREFERRED EMBODIMENTS

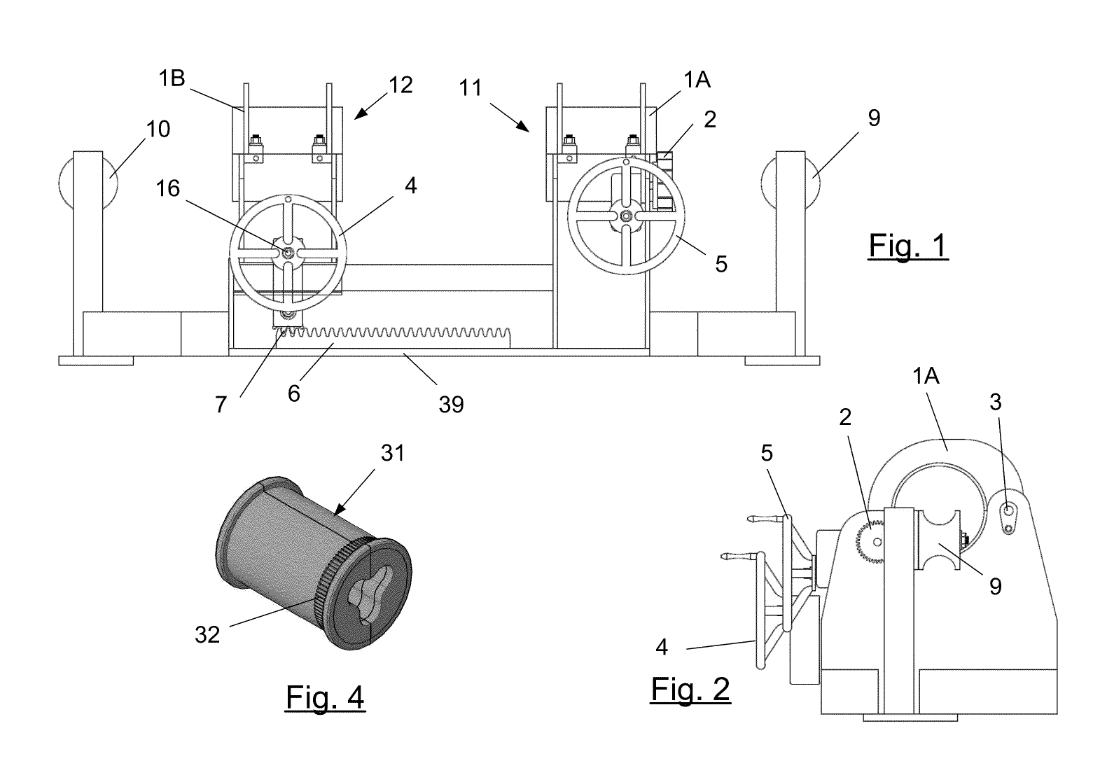

FIGS. 1, 2 and 3 are side, end and top plan views of a coupling apparatus or “coupler” according to a first embodiment of the present invention.

The coupler includes a frame 39 upon which are mounted a first retaining assembly 11 and a second retaining assembly 12 for retaining respective connector assemblies. The retaining assemblies may be brought relatively toward and away from each other by a translation assembly which comprises a rack 6 mounted to the frame and which meshes with a pinion 7. The pinion 7 is coupled to a drive train of the second retaining assembly which is driven by an axle 16, to one end of which there is mounted a wheel 4. Accordingly, upon a worker rotating wheel 4 the second retaining assembly 12 may be brought toward and away from the first retaining assembly 11.

With reference to the end view of FIG. 2, each of the retaining assemblies 11, 12 includes a yoke 1A, 1B which has an upper part that can be pivoted about a shaft 3 in order to open the yoke.

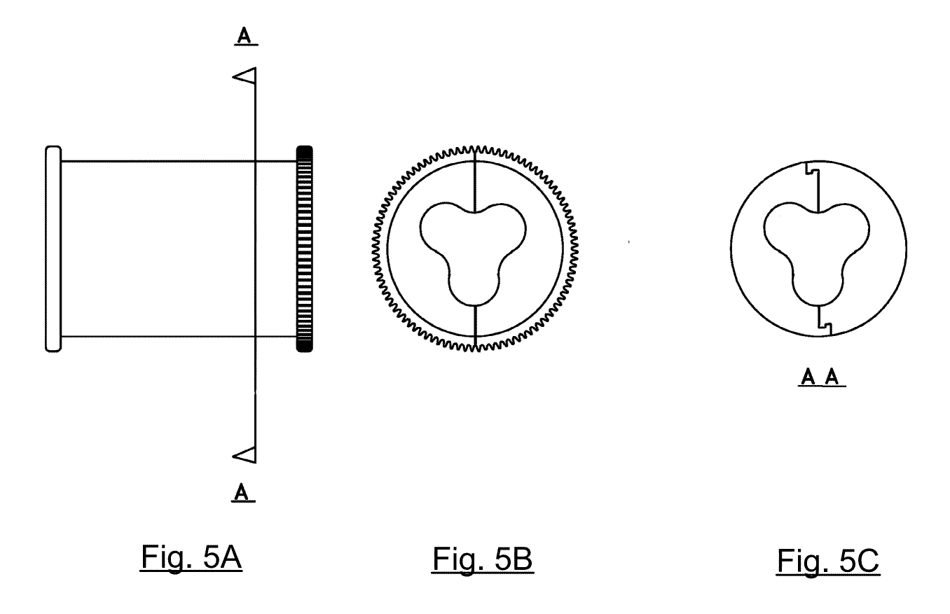

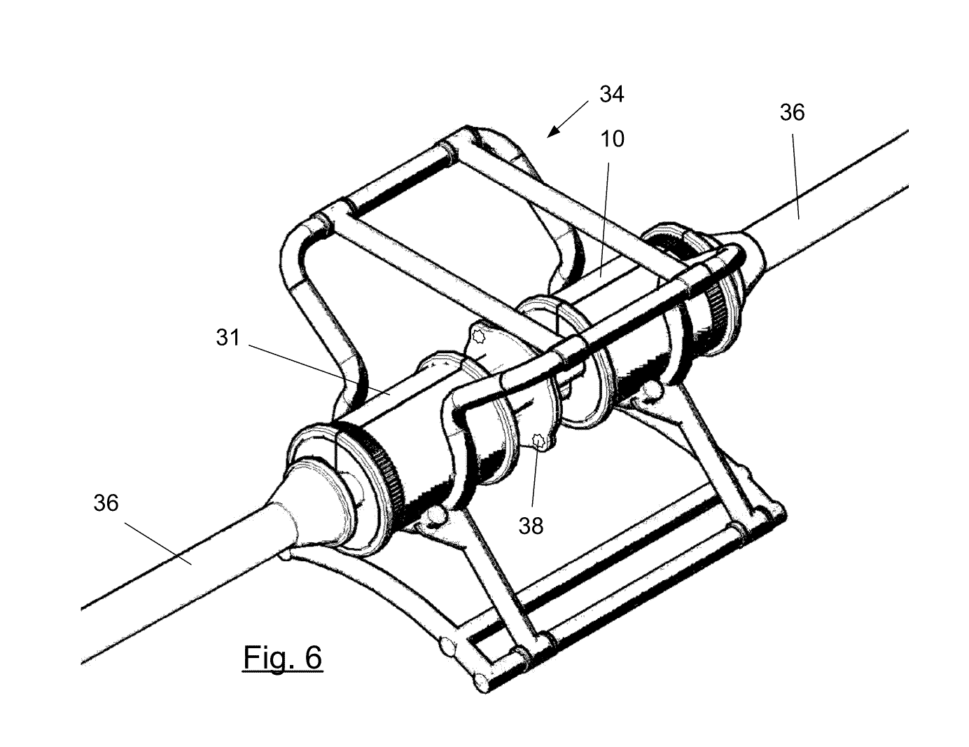

A connector adaptor in the form of a split sleeve 31, as shown in FIGS. 4 and 5A to 5C can then be inserted into the open yoke. The sleeve is formed of two interlocking and detachable parts that cooperate to define a space shaped to snugly retain the connector. Since the sleeve is preferably made of a synthetic material, e.g. polypropylene or polyurethane or nylon, it prevents metal-to-metal contact between the connector and the inner ring of the yoke 1. It will be realized that a number of sleeves 31 may be made, all having the same outer configuration, but with different inner configurations to accommodate the profiles of different types of connectors. Consequently, the sleeve 31 comprises an adaptor between different shaped electrical connectors and the coupling apparatus.

The first retaining assembly 11 is fitted with an arrangement for rotation of the sleeve including pinion 2. The pinion meshes with teeth 32 formed on the outside of the sleeve 31. The pinion 2 is coupled to a drive wheel 5 by a drive train associated with the first retaining assembly 11. Consequently, upon a worker rotating wheel 5, the pinion 2 is rotated which in turn rotates the sleeve 31 within yoke 1.

In the presently described embodiment, there is no such drive train for rotating the sleeve retained in the second retaining assembly 12 although in other embodiments of the invention both retaining assemblies may incorporate an arrangement to rotate their respective sleeves. Similarly, in other embodiments of the invention both of the retaining assemblies may be moved back and forth along the frame.

Cable supports in the form of sheaves 9 and 10 are provided at opposing ends of the frame 39 to support respective cables of the first connector and the second connector. The cable supports help to reduce strain between the internal connection of the cables and the connectors. As previously mentioned, the cable supports 9 and 10 include sheaves or rollers to support the cables.

The cable supports 9 and 10 assist workers in installing the connectors into the yokes of the first and second retaining assemblies.

In use first and second adaptors 31 are initially fitted around each of the opposing connector assemblies that are to be coupled together. The adaptors 31 are then lifted into the yokes 1A and 1B which have previously opened to receive them. The yokes are then closed so that teeth 32 of adaptor 31 meshes with pinion 2 in the case of retaining assembly 11. The cables from each of the connectors are located over sheaves 9 and 10. An operator then turns wheels 4 and 5 in order to bring the connectors together and orientate them so that they are aligned to be mated together. Once mated together the connectors, with sleeves 31 still about them can be bolted together and lifted from the yokes onto a frame 34 as shown in FIG. 6 where the cables 36 and bolts 38 can also be seen.

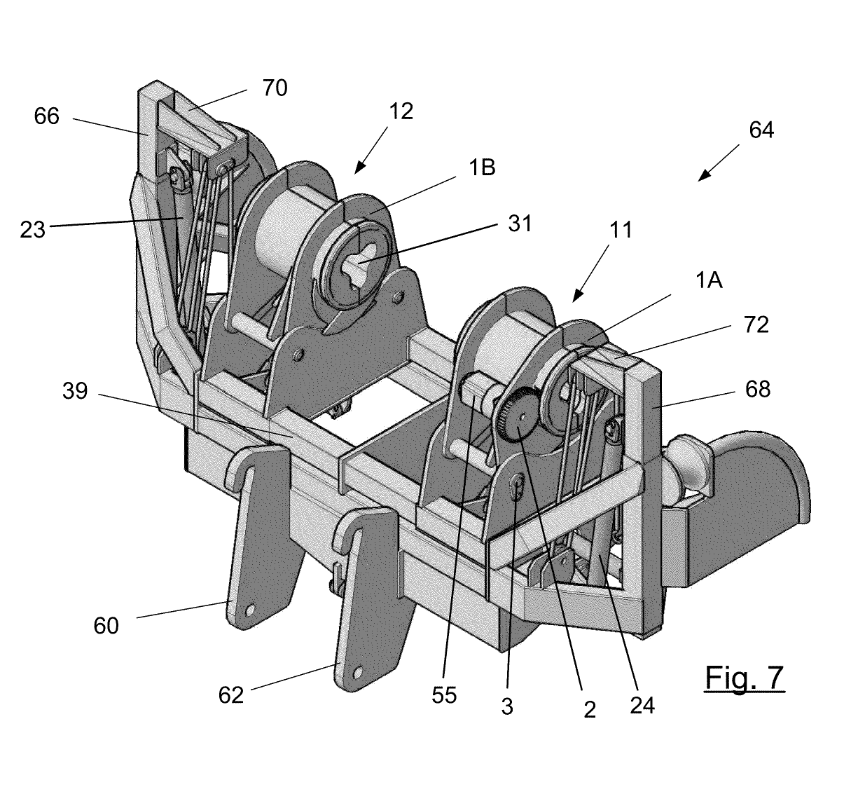

Referring now to FIGS. 7 to 10, there are shown isometric, rear, top and end views of a coupling apparatus 64 according to a second embodiment of the invention which is preferred for use in outside environments such as open-cut mines.

Coupler 64 is intended to be mounted to a vehicle by means of brackets 60 and 62 so that it may be moved to a location on site where it is required. Coupler 64 is fitted with substantially more power actuators, such as hydraulic rams and motors, than that of the embodiment of FIG. 1. The various hydraulic rams and motors are hydraulically powered by the vehicle to which it is mounted.

A motor 55 is provided to power the rotation pinion 2 so that the rotation wheel 4 of FIG. 1 is not present. Similarly, a translation assembly in the form of hydraulic actuators 25 and 26 are provided to bring the first retaining assembly 12 and the second retaining assembly 11 toward and away from each other by sliding them along a member of frame 39.

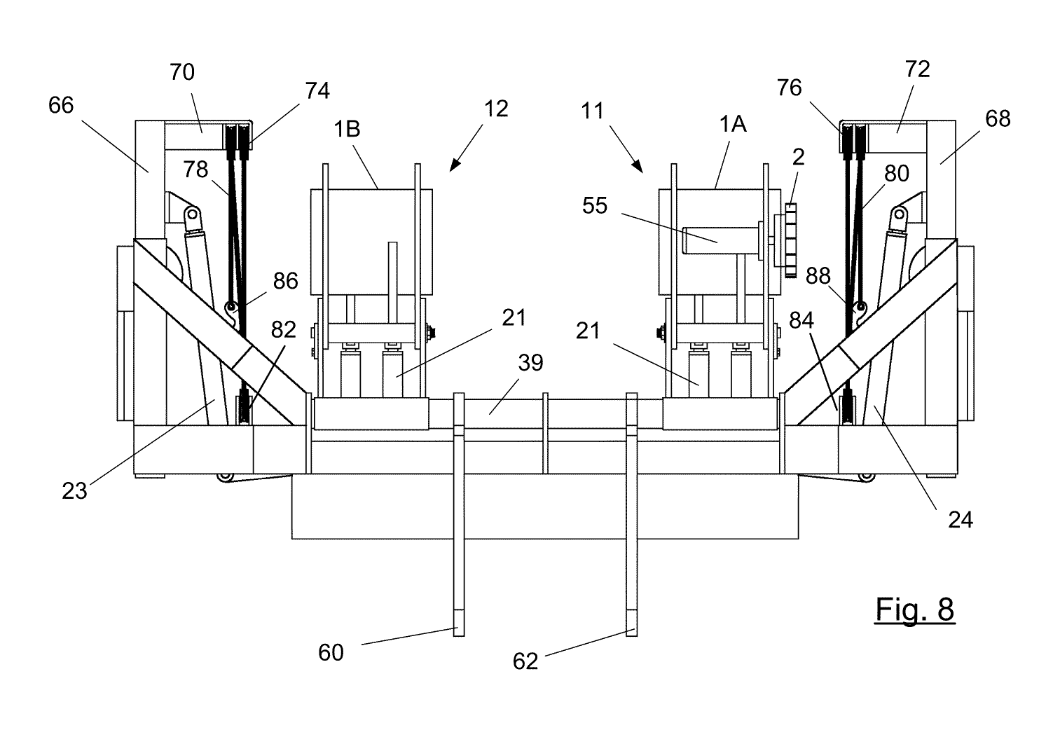

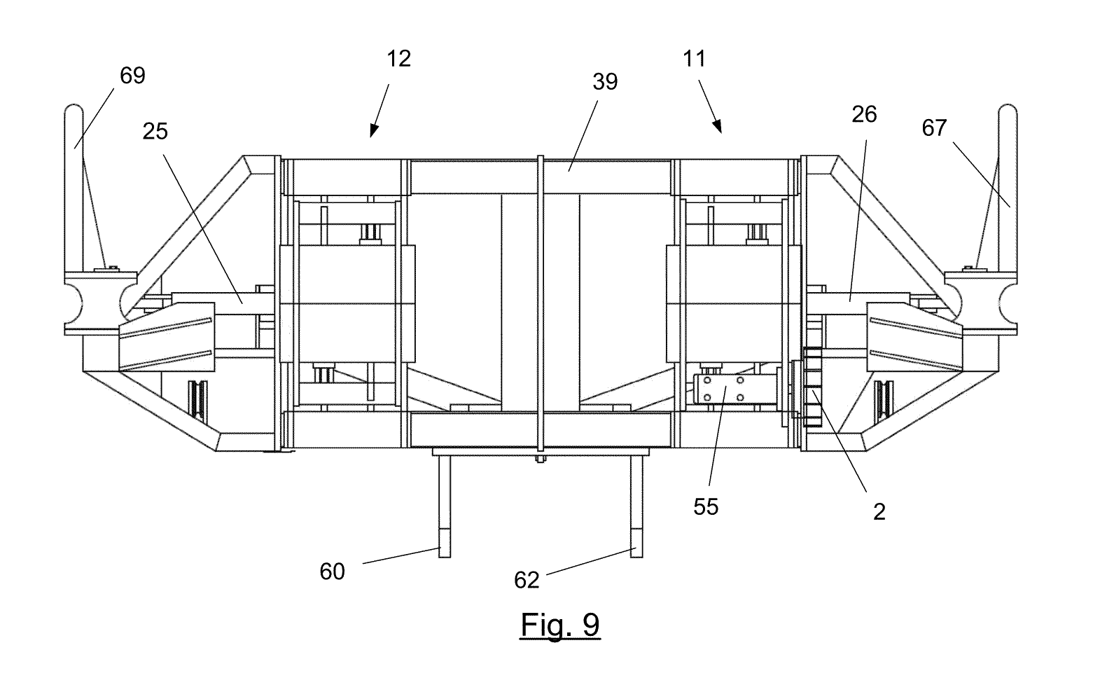

Furthermore, with reference to FIG. 8, yoke actuators 21 are provided to open and close the yokes so that no hands-on operator intervention is required.

Hydraulic rams 23 and 24 are also provided as part of riser assemblies at opposite ends of the coupler which also includes telescopic arms 66 and 68. The hydraulic rams 23 and 24 are arranged to extend telescopic arms 66 and 68 which terminate at their upper ends in lateral beams 70 and 72 on which pulleys 74 and 76 are mounted respectively. Lines 78 and 80 are threaded through pulleys 74 and 76 and frame-mounted pulleys 82 and 84. At one end the lines 78 and 80 are fixed to a frame of the coupler whereas at their opposite free ends they terminate in lifting hooks 86 and 88. Consequently, extending the telescopic arms causes the hooks to rise and retracting the arms causes the hooks to lower. In an alternative embodiment the lines may be wound on a powered winch fast with frame 39.

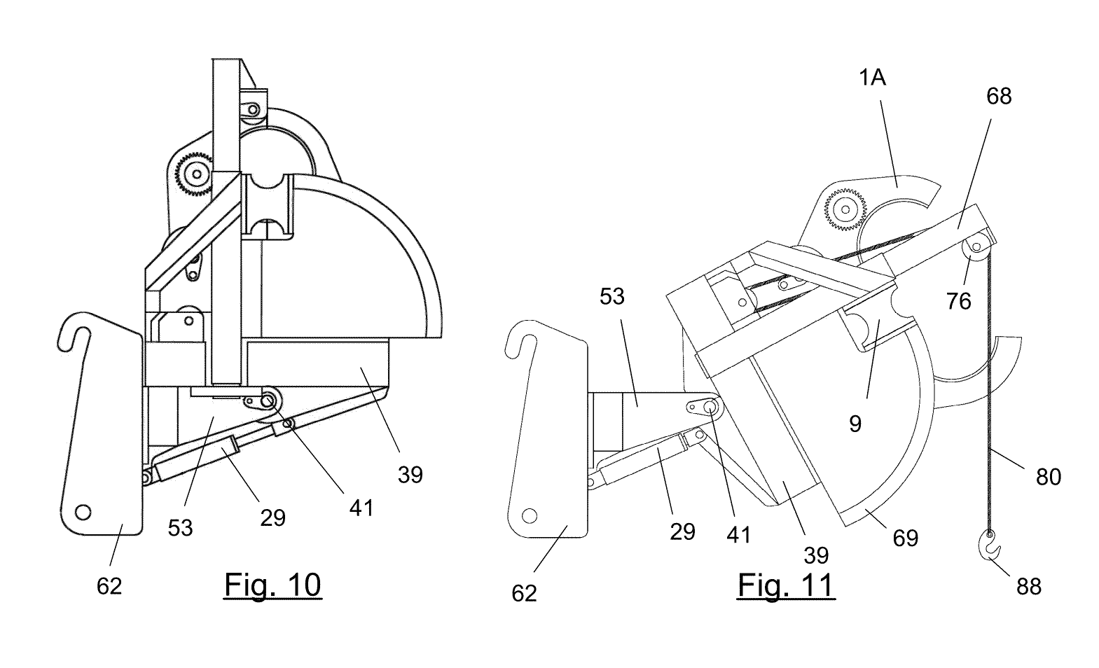

With reference to FIG. 10, frame 39 of the coupler is connected to tilt assembly 53 by a shaft 41 in order that it can be tilted about the shaft to assist in raising connector assemblies to be coupled as will be described shortly. A power actuator in the form of a hydraulic ram 29 is provided to power the tilting operation.

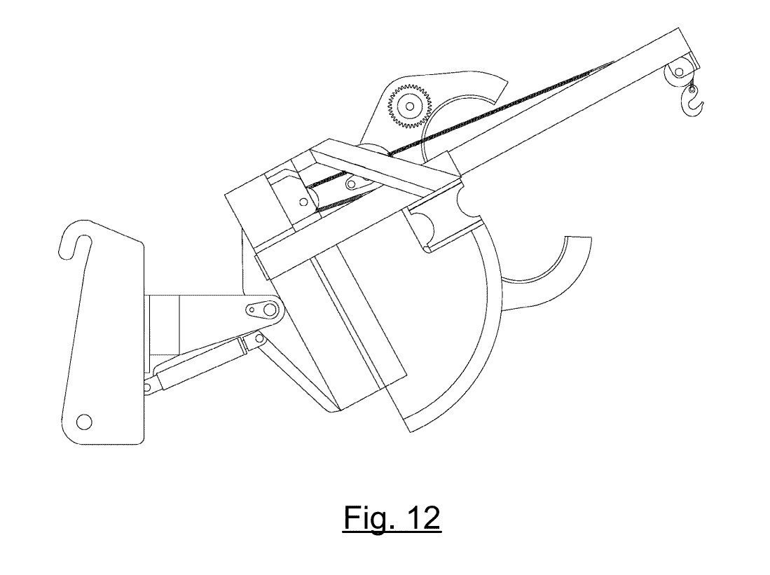

With reference to FIGS. 11 to 14, in use the tilt actuator 29 is operated to tilt the coupler toward the ground as shown in FIG. 11. In this position the cable guides 69 and 67 are lowered. The cable guides are useful in guiding the cables onto the cable support sheaves 9 and 10. Telescopic arms 66 and 68 are extended by operation of rams 23 and 24 as shown in FIG. 12 so that they reach past the yokes 1A, 1B. The yokes 1A, 1B are also opened by operation of rams 21 (which are visible in FIG. 8).

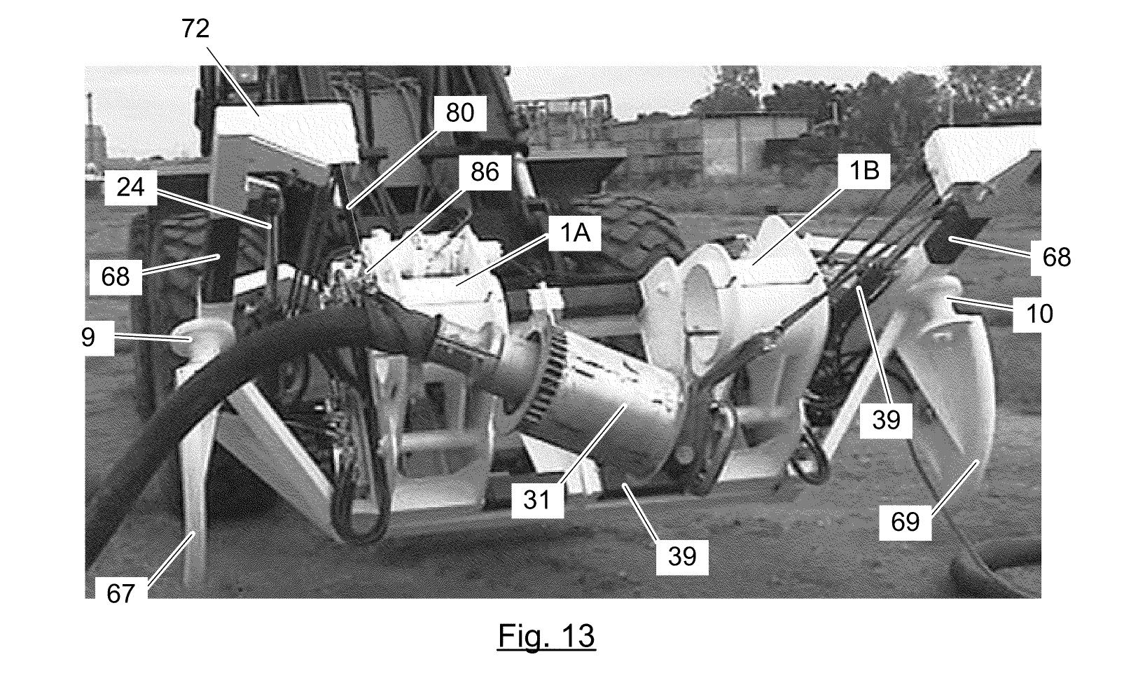

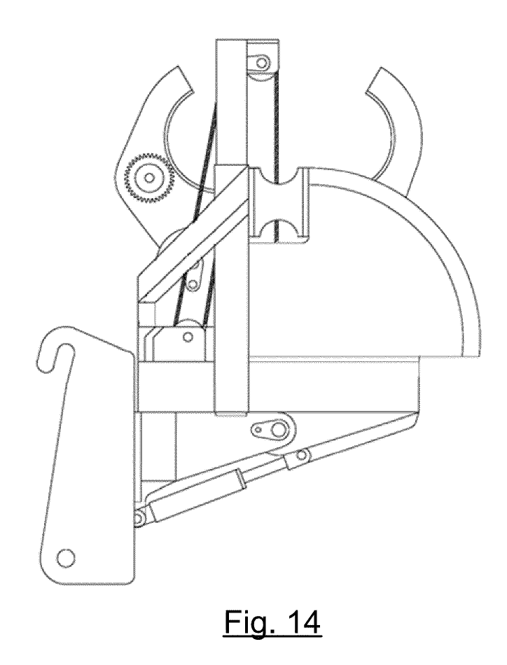

As shown in FIG. 13, the lifting hooks 86, 88 at the end of lines 78, 80 are then attached to the end of the first connector assembly 90 which has already had an adaptor sleeve 31 fitted about it. The lines 78 and 80 are then withdrawn, by extending arms 66 and 68 to raise the connector assembly 90 as shown in FIG. 13. By varying the length of lines 78 and 80 the connector 90 and adapter sleeve 31 can be positioned over the open yoke 1A. The lines 78 and 80 are then loosened to lower the connector and adapter sleeve 31 into the open yoke 1A in the position as depicted in FIG. 14.

A similar operation is then carried out to lift and maneuver the other connector assembly including its fitted adapter sleeve 31 into yoke 1B. The top portions of the yokes are then swung down and locked. This entails using the hydraulic actuators 21 to open and close the yokes. It is preferred that the hydraulic circuit that controls the yokes requires an operator to use both hands, e.g. one to power the circuit and one to initiate an open or close command, in order to reduce the risk of an operator's hand being caught during yoke closure.

Once the first and second connectors are captured in their respective yokes, motor 55 is operated so that pinion 2 rotates and thereby rotates the sleeve, with which it meshes and so the connector that are installed within retaining assembly 11. Rotation continues until the connectors are correctly aligned, i.e. the socket portions of the connectors are lined up collinear with dowel portions of the opposing connector. The connectors are then brought together by operating rams 25 and 26 (FIG. 9) to slide retaining assemblies 12 and 11 along the rails of frame 39.

Once the connectors have been rotationally aligned and drawn together by operating the rams 25 and 26 until they are interconnected, they are then bolted together in place. The yokes 1A, 1B are then opened and the interconnected cable can be lifted from the yokes and placed in a support such as that of FIG. 6.

This last operation includes the use of operating rams 23 and 24 to thereby lift the telescopic arms 66 and 68 and lines 80 and 86 to lower the coupled connectors. After the coupled connectors have been removed from the coupling apparatus the adaptor sleeves are then split to remove them so that they can be used for the next coupling.

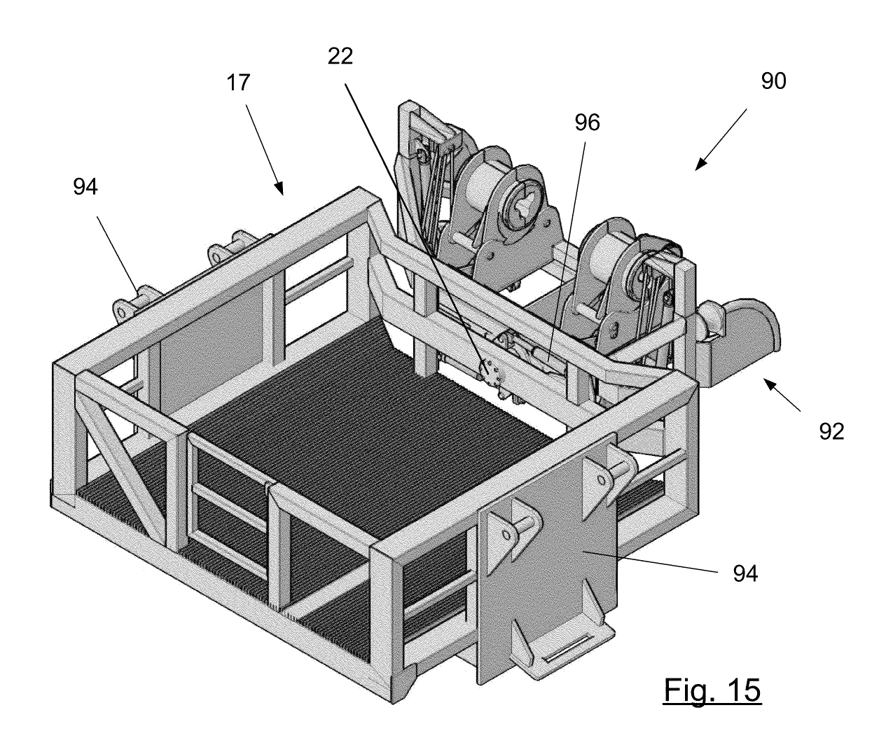

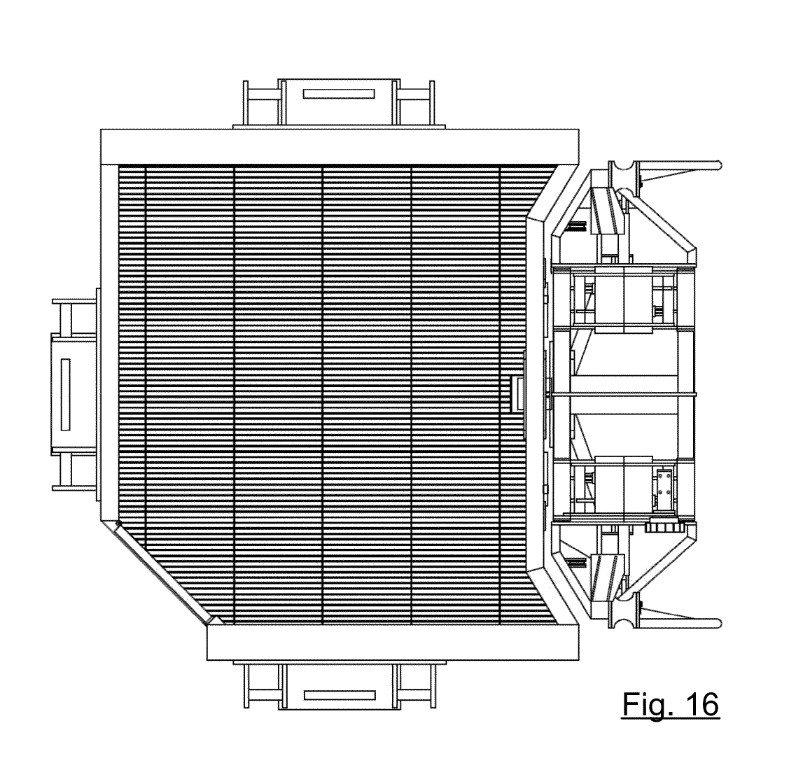

Referring now to FIGS. 15 to 18, there is depicted a coupling apparatus 90 according to a third embodiment of the invention which is intended for use in underground mines where the mine roof may be sloping. The electrical cables are typically strung along the mine roof and so this embodiment of the coupler is designed to accommodate for that slope. The coupling apparatus 90 comprises a platform portion 17 which is pivotally connected to coupling assembly 92 that is very similar to the coupling apparatus 64 of FIG. 7. However, whereas the coupling apparatus 64 included a pair of brackets for attachment to a vehicle, the coupling assembly 92 is coupled to the platform 17 by a pivot 22. As will be explained

Vehicle attachment brackets 94 are fastened about the platform so that the platform can be readily secured to a mining vehicle.

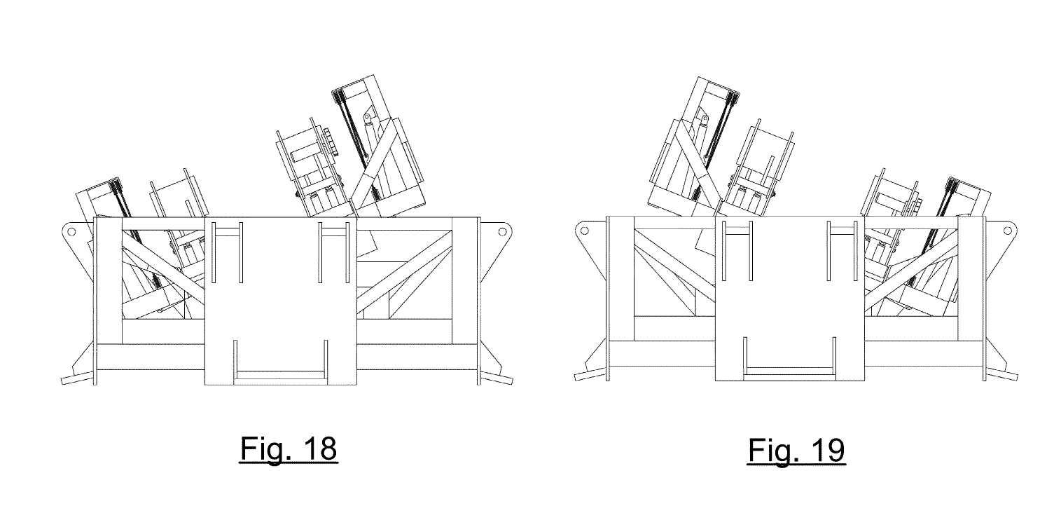

With reference to FIG. 15, the platform 17 is pivotally coupled to tilt assembly 53 by pivot 22. An actuator is provided so that the tilt assembly 53 can be rolled about the pivot 22 as desired from the position shown in FIG. 18 to that shown in FIG. 19. In the embodiment shown in FIG. 15 an actuator in the form of a hydraulic ram 96 is used. Alternatively a stepper or indexing motor might also be used for the actuator in some embodiments.

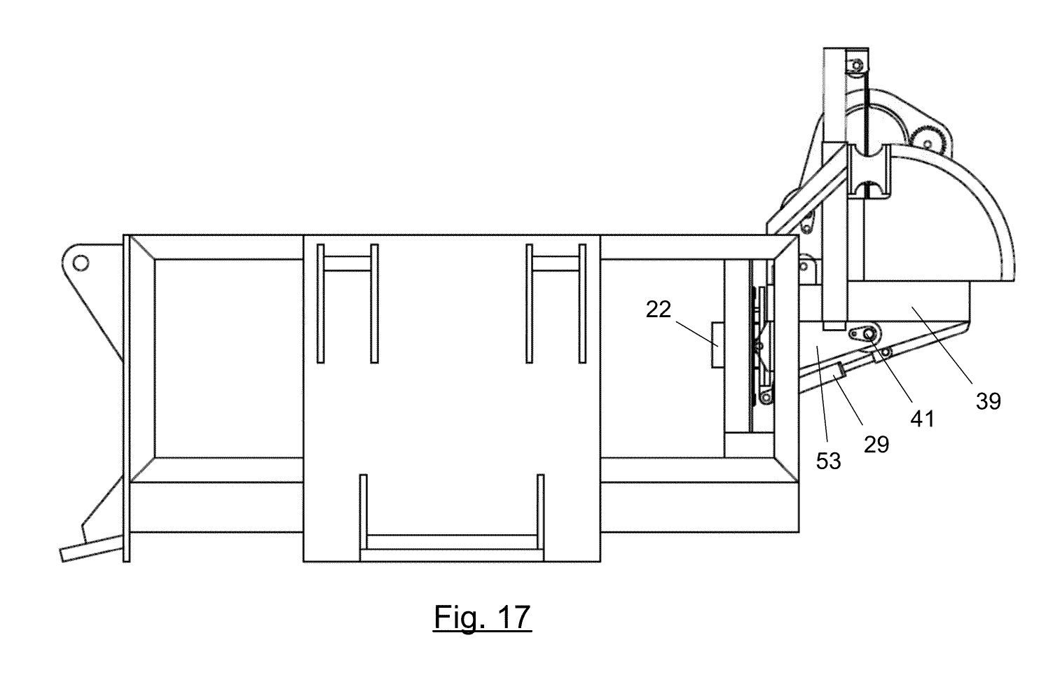

Referring to FIG. 17, frame 39 of the coupler is connected to tilt assembly 53 by a shaft 41 in order that it can be tilted about the shaft in the manner previously described with reference to FIGS. 11 to 14.

A power actuator in the form of a hydraulic ram 29 is provided to power the tilting operation.

In use, platform 17 will typically be mounted to a vehicle. Once the vehicle is at the required location the tilt assembly 53 and so the coupler frame and coupler assembly are rolled about pivot 22 so that the frame is brought to the horizontal or a desired slope. This operation compensates for any steep sloping of the ground on which the vehicle rests.

The tilt actuator 29 is then operated to tilt the coupler toward the ground and the connectors are loaded into the yokes as previously described with reference to FIGS. 11 to 14.

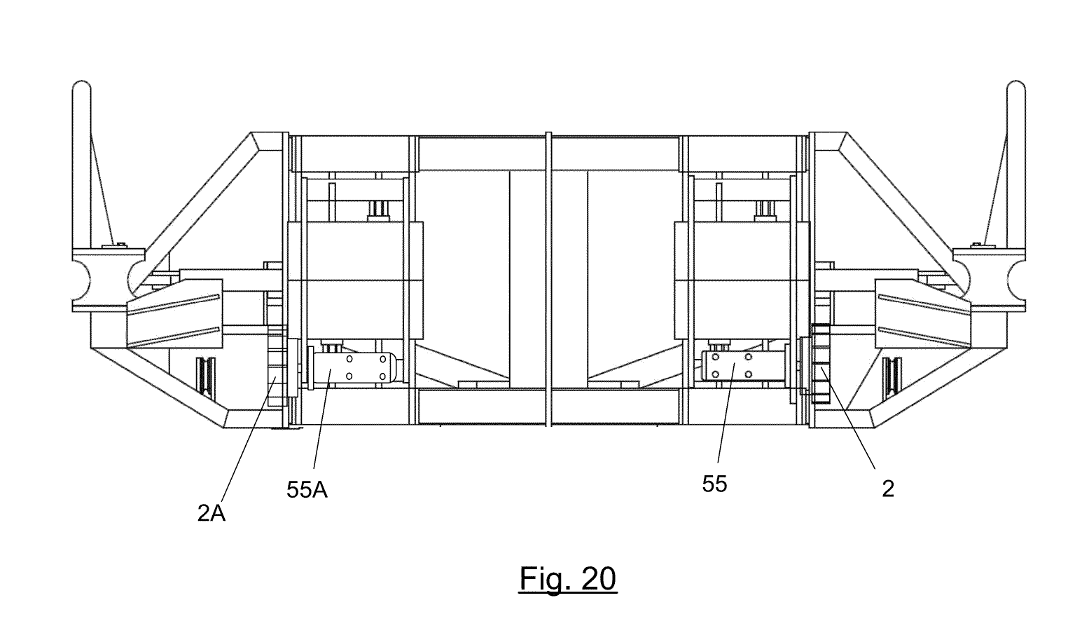

FIG. 20 shows a further embodiment of the invention wherein both retaining assemblies 11 and 12 are fitted with rotation assemblies comprising motors 55, 55A driving pinions 2 and 2A respectively. This embodiment may be used where it is important that the coupling assemblies not be rotated through more than 90 degrees each as doing so might rupture or damage the cables to which they are connected. Accordingly, each rotation assembly provides up to 90 degrees of rotation thereby providing a maximum of 180 degrees relative rotation between them in use.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A coupler to interconnect first and second connector assemblies of respective first and second electrical cables and able to be released from the cables after interconnection, the coupler including:
a first retaining assembly to retain the first connector assembly;
a second retaining assembly to retain the second connector assembly;
a translation assembly for relative motion of said first retaining assembly and said second retaining assembly toward each other to thereby mate the first connector assembly with the second connector assembly.

2. A coupler according to claim 1, wherein at least one of the first and second retaining assemblies includes an arrangement for rotation of a corresponding one of the first and second connector assemblies.

3. A coupler according to claim 1, wherein the translation assembly is arranged to move both the first and second retaining assemblies toward each other either simultaneously or independently.

4. A coupler according to claim 1, wherein at least one of the first retaining assembly and the second retaining assembly comprises a yoke for retaining one of the first connector assembly and the second connector assembly.

5. A coupler according to claim 4, wherein the yoke comprises opposing parts which can be opened to receive a connector assembly.

6. A coupler according to claim 5, wherein the opposing parts define a receptacle for an adaptor which holds the connector in use.

7. A coupler according to claim 4, wherein the opposing parts of the second yoke are hingedly connected so that a first part of yoke may be pivoted away from a second part of the yoke.

8. A coupler according to claim 7, including a power actuator to open and close the first yoke.

9. A coupler according to claim 6, including a drive train for rotating the adaptor within the yoke.

10. A coupler according to claim 9, wherein the drive train includes a pinion arranged to mesh with teeth formed about the adaptor.

11. A coupler according to claim 1, wherein the translation assembly comprises a rack and pinion arrangement associated with the second retaining assembly.

12. A coupler according to claim 1, wherein the first retaining assembly and the second retaining assembly are mounted upon a common frame.

13. A coupler according to claim 12, wherein the translation assembly includes powered actuators arranged to slide the first retaining assembly and the second retaining assembly along members of the frame.

14. A coupler according to claim 12, including cable supports mounted adjacent the first retaining assembly and the second retaining assembly for supporting respective cables of the first connector assembly and the second connector assembly during use.

15. A coupler according to claim 14, including cable guides arranged to direct cables of the connector assemblies to respective cable supports during use.

16. A coupler according to claim 15, including powered risers for lifting of the first cable and the second cable to assist in installing and removing the connector assemblies to and from the retaining assemblies.

17. A coupler according to claim 12, wherein said frame is coupled to a support by a linkage for tilting the frame relative to the stand so that the first and second retaining assemblies may be tilted down.

18. A coupler according to claim 17 wherein the frame is pivotally mounted to the stand so that the frame may be rolled through a first angle relative to the stand.

19. A coupler according to claim 18, wherein the stand comprises a platform or a “basket” for an operator to stand in while using the coupling apparatus.

20. An adaptor for installing about an electrical connector to thereby produce a connector assembly for installation into a coupler according to claim 1, said adaptor comprising:
at least first and second parts defining a space for snugly receiving the electrical connector therein; and
an external surface for forcing by a rotation member.

21. An adaptor according to claim 20, wherein the at least first and second parts comprise two portions that are detachably interlocking.

22. An adaptor according to claim 20, wherein the external surface is formed for meshing with gears of a pinion to thereby receive rotational force.
